(19) United States
(12) Patent Application Publication
(10) Pub. No.: US 2011/0273701 A1
(43) Pub. Date: Nov. 10, 2011

(54) METHODS FOR CHARACTERIZATION OF THE MECHANICAL PROPERTIES OF THIN FILMS AND TEST STRUCTURES FOR PERFORMING THE SAME

(75) Inventors: Manish Kothari, Cupertino, CA (US); Sauri Gudlavalleti, San Jose, CA (US); Satyadev Rajesh Patel, Palo Alto, CA (US)

(73) Assignee: QUAL COMM MEMS Technologies, Inc., San Diego, CA (US)

(21) Appl. No.: 12/680,512

(22) PCT Filed: Sep. 28, 2007
(86) PCT No.: PCT/US07/21004

§ 371 Date: Mar. 26, 2010

(51) Int. Cl. G01L 1/24; G02B 26/00

(52) U.S. Cl. 356/35.5; 359/290

(57) ABSTRACT

A test structure allows one or more deposited thin film layers to be moved such that mechanical properties of the thin film layer or layers may be determined. Methods for characterizing the mechanical properties of the deposited thin film layer include the determination of a transition voltage of the movable thin film layer in the test structure, or the mechanical stiffness of the movable layer, and/or a determination of residual stress within the movable layer. Methods may also include the determination of creep rate or fatigue, as well as the variance in mechanical properties of the movable layer at various temperatures. Test structures used with the testing methods may include structures which interferometrically modulate incident light, enabling electrical or optical determination of the state of the test structures.

### BACKGROUND OF THE INVENTION

1. Field of the Invention

This invention relates to methods for characterization of the mechanical properties of thin films and test structures for performing the same, for example thin films to be used in small scale electromechanical devices such as microelectromechanical systems (MEMS) or nanoelectromechanical systems (NEMS) devices.

2. Description of the Related Art

MEMS include micro mechanical elements, actuators, and electronics. Although the term MEMS is used through the specification for convenience, it will be understood that the term is intended to encompass smaller-scale devices, such as NEMS. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. As described further herein, an interferometric modulator may comprise a pair of conductive plates, one or both of which may be transparent and/or reflective in whole or part and capable of relative motion upon application of an appropriate electrical signal. One plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF THE INVENTION

In one aspect, a method of characterizing a deposited film layer includes providing a plurality of test structures formed on a substrate, where each test structure includes a film layer spaced apart from an electrode by a cavity, the film layer being configured to be actuated via the electrode to move into the cavity, where the film layer is supported by at least a residual portion of a sacrificial layer, actuating one or more of the plurality of test structures, determining the response of the actuated test structures, and characterizing mechanical characteristics of the film layer based on the response of the actuated test structures.

In another aspect, a package including a precursor stack on a substrate for use in characterizing a film layer includes a substrate, a patterned electrode layer formed over the substrate, where the electrode layer is patterned to define a plurality of test structure regions, each the test structure region including an electrode, a dielectric layer formed over the patterned electrode layer, and a sacrificial layer formed over the dielectric layer, where the precursor stack on the substrate is packaged prior to patterning of the sacrificial layer.

In another aspect, a test structure for characterizing a deposited thin film layer includes an optical stack formed over a substrate, the optical stack including: a driving electrode, and an insulating layer, and a support formed over the optical stack, where the support includes a substantially contiguous substantially annular portion of a sacrificial layer on which the thin film layer is deposited, the substantially annular portion of the sacrificial layer extending about and defining a cavity due to a portion of the sacrificial layer being removed, where the deposited thin film layer is spaced apart from the optical stack by the cavity.

In another aspect, a method of characterizing a deposited thin film layer includes providing a plurality of test structures formed on a substrate, where the test structures include a film layer spaced apart from an electrode by a cavity, the film layer being configured to be actuated via the electrode to move through the cavity, actuating the test structures via the electrodes, determining the response of the test structures, and determining a mechanical stiffness of the film layer.

In another aspect, a test structure for characterizing a film layer includes means for reflecting at least a portion of incident light, means for deforming the reflecting means to move into a cavity between the reflecting means and the deforming means, and means for spacing the reflecting means apart from the deforming means, where the spacing means extends substantially continuously around a perimeter of the cavity.

In another aspect, a program storage device is provided, the program storage device including instructions that when executed by a processor perform a method including actuating a test structure, the test structure including a thin film spaced apart from an optical stack by a cavity, where the film layer is supported by at least a residual portion of a sacrificial layer, where actuating the test structure include causing the film layer to deflect into the cavity, determining the response of the test structure, and characterizing mechanical characteristics of the film layer based on the response of the actuated test structures.

### BRIEF DESCRIPTION OF THE DRAWINGS

FIG. 1 is an isometric view depicting a portion of one type of interferometric modulator display in which a movable reflective layer of a first interferometric modulator is in a relaxed position and a movable reflective layer of a second interferometric modulator is in an actuated position.

FIG. 2 is a system block diagram illustrating one type of an electronic device incorporating a 3×3 interferometric modulator display.

FIG. 3 is a diagram of movable mirror position versus applied voltage for one exemplary interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIG. 6A is a cross section of the device of FIG. 1.

FIG. 6B is a cross section of an alternative type of an interferometric modulator.

FIG. 6C is a cross section of another alternative type of an interferometric modulator.

FIG. 6D is a cross section of yet another alternative type of an interferometric modulator.

FIG. 6E is a cross section of an additional alternative type of an interferometric modulator.

FIGS. 7A-7C illustrate various steps in the process of forming an embodiment of a test structure.

FIG. 8 is a bottom plan view of one embodiment of a test structure.

FIG. 9 is a cross section of the test structure of FIG. 9, taken along the line 10-10.

FIG. 10 is a cross section of the test structure of FIG. 10, when the test structure is in an actuated state.

FIGS. 11A-11F illustrate various steps in the process of fabricating a test structure such as the test structure of FIG. 9.

### DETAILED DESCRIPTION

The following detailed description is directed to certain specific embodiments of the invention. However, the invention can be embodied in a multitude of different ways. In this description, reference is made to the drawings wherein like parts are designated with like numerals throughout. MEMS devices of similar structure to those described herein can also be used in non-display applications such as in electronic switching devices.

The mechanical characteristics of deposited thin films play a critical role in the design and operation of MEMS and other devices which include such thin films. It is desirable to accurately characterize the mechanical characteristics of these thin films, such as the residual stress within the thin films and the change in the mechanical properties over time, under load, and at varying temperatures. By providing a test structure which interferometrically modulates incident light, the position of a movable layer can be determined both on the basis of the electrical characteristics of the test structure and the optical characteristics of the test structure. Rapid and accurate determinations of the position of the modulator may be made. In addition, the design of the test structure may be configured to simplify analysis of the mechanics of the test structure, as well as to facilitate fabrication of the test structure.

### Interferometric Modulator Structures

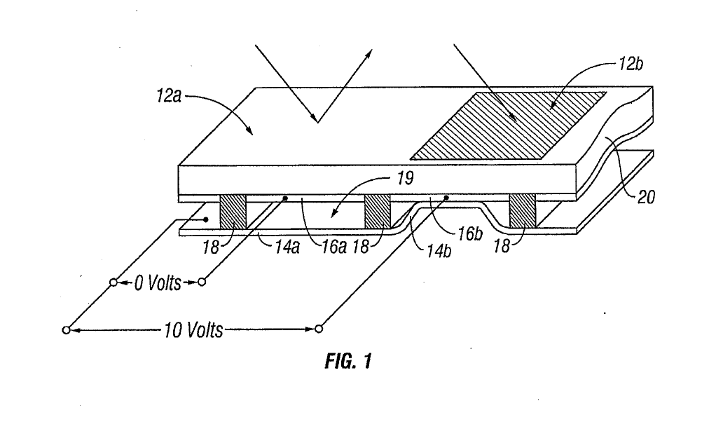

One type of interferometric modulator display comprising an interferometric MEMS display element is illustrated in FIG. 1. In these devices, the pixels may be in either a bright or dark state. In the bright (“on” or “open”) state, the display element reflects a large portion of incident visible light to a user. When in the dark (“off” or “closed”) state, the display element reflects little incident visible light to the user. The light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. The interferometric modulator display may comprise a row/column array of these interferometric modulators. Each interferometric modulator includes a pair of reflective layers positioned at a variable and controllable distance from each other to form a resonant optical gap with at least one variable dimension. One of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

The layers of the optical stack 16 may be patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

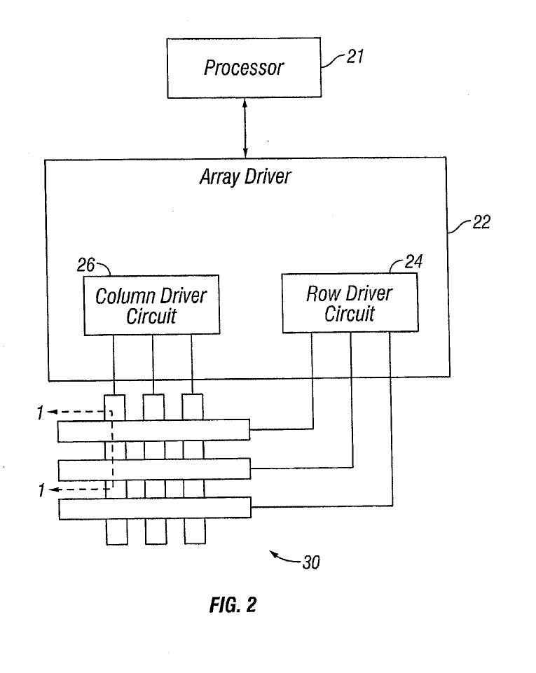

FIGS. 2 through 5B illustrate one process and system for using an array of interferometric modulators in a display application.

FIG. 2 is a system block diagram illustrating an electronic device for which aspects of the invention may provide beneficial. The electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

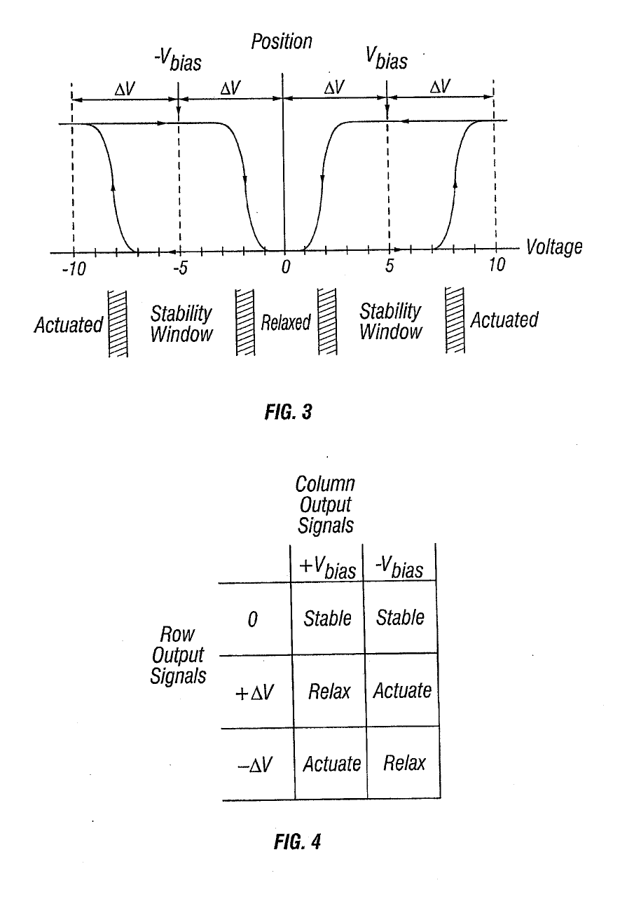

The processor 21 may also be configured to communicate with an array driver 22. The array driver 22 may include a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, forms a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used.

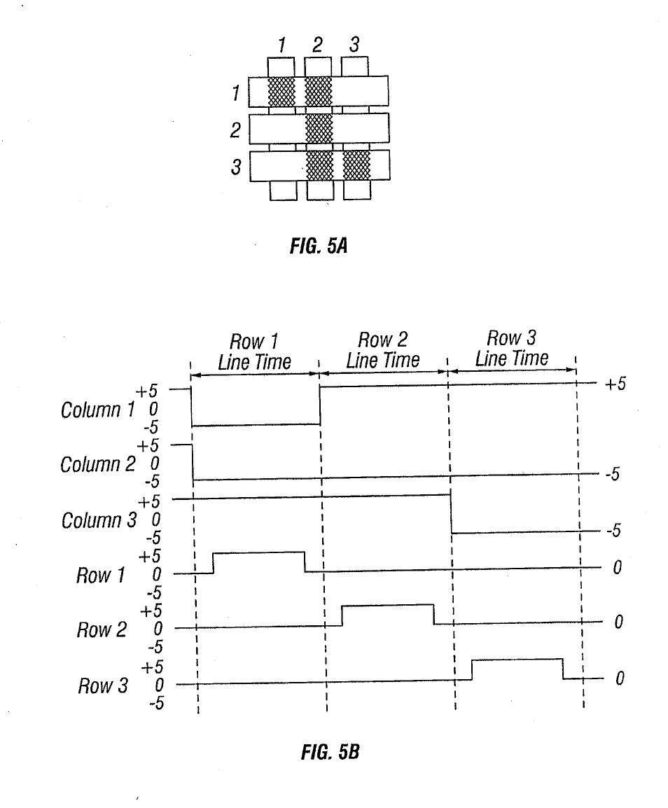

FIGS. 4, 5A, and 5B illustrate one actuation protocol for creating a display frame on the 3×3 array of FIG. 2. FIG. 4 illustrates a set of column and row voltage levels that may be used for pixels exhibiting the hysteresis curves of FIG. 3. Actuating a pixel may involve setting the appropriate column to −V_{bias}, and the appropriate row to +ΔV, which may correspond to −5 volts and +5 volts, respectively. Relaxing the pixel may be accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. Voltages of opposite polarity than those described above can be used, e.g., actuating a pixel can involve setting the appropriate column to +V_{bias}, and the appropriate row to −ΔV. Releasing the pixel may be accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

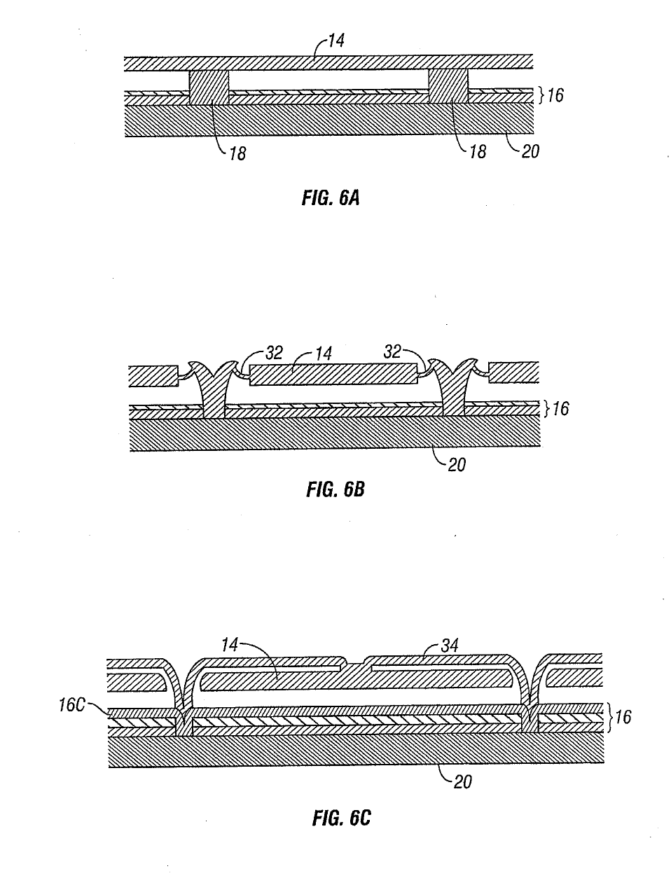

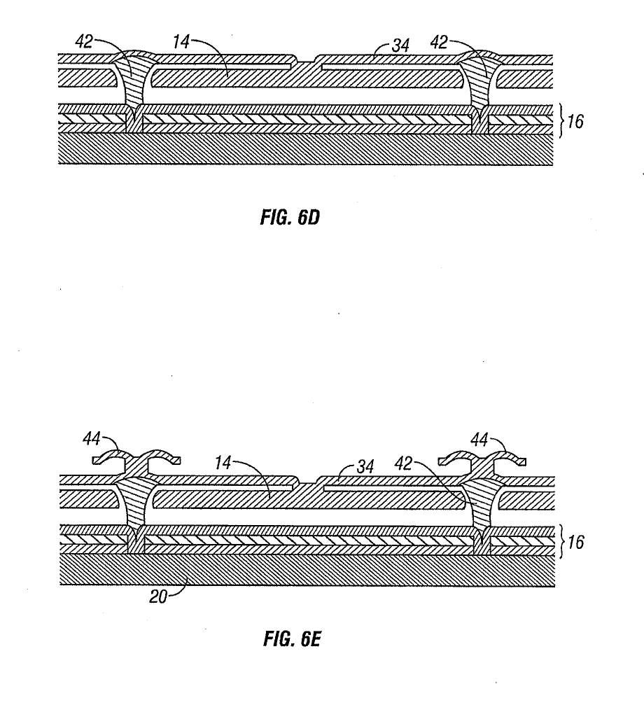

The details of the structure of interferometric modulators that operate in accordance with the principles set forth above may vary widely. For example, FIGS. 6A-6E illustrate five different examples of the movable reflective layer 14 and its supporting structures. FIG. 6A is a cross section associated with FIG. 1, where a strip of metal material 14 is deposited on orthogonally extending supports 18. In FIG. 6B, the moveable reflective layer 14 is attached to supports at the corners only, on tethers 32. In FIG. 6C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. FIG. 6D illustrates support post plugs 42 upon which the deformable layer 34 rests. The movable reflective layer 14 remains suspended over the gap, as in FIGS. 6A-6C, but the deformable layer 34 does not form the support posts by filling holes between the deformable layer 34 and the optical stack 16. Rather, the support posts are formed of a planarization material, which is used to form support post plugs 42. FIG. 6E is a variation of FIG. 6D, but may also be adapted to work with any of FIGS. 6A-6C, as well as others not shown. In FIG. 6E, an extra layer of metal or other conductive material has been used to form a bus structure 44. This allows signal routing along the back of the interferometric modulators, eliminating a number of electrodes that may otherwise have had to be formed on the substrate 20.

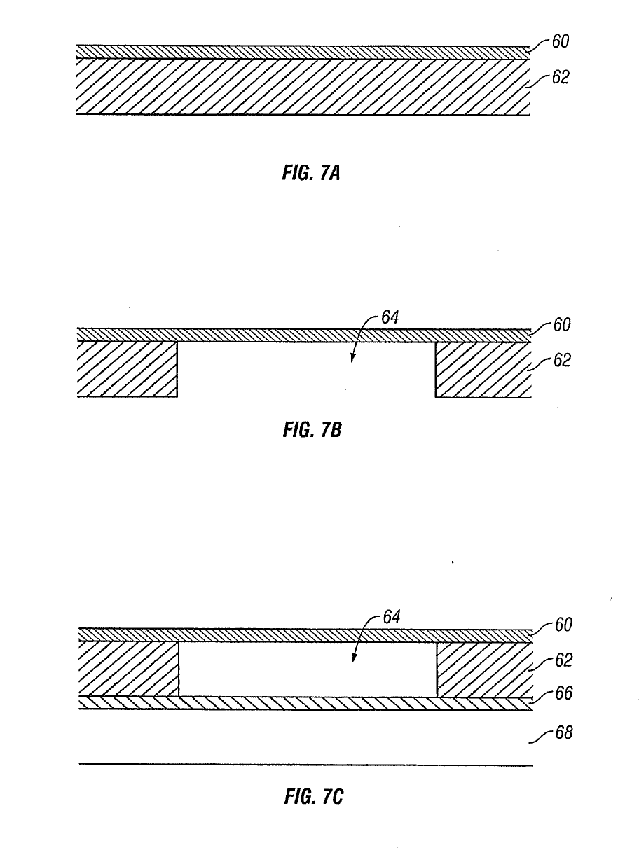

The interferometric modulators may function as direct-view devices, in which images are viewed from the front side of the transparent substrate 20, the side opposite to that upon which the modulator is arranged. The reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, additional benefits derive from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

### Test Structures

The operation of a MEMS device which includes a movable layer is dependent in large part upon the mechanical characteristics of the movable layer. In order to accurately predict the behavior of such a MEMS device, it is very helpful to accurately assess the characteristics of the various individual or combined layers in a MEMS device, and in particular the layer or layers that make up the movable layer. Because the mechanical properties of the MEMS device affect the operation of the MEMS device, the design of the MEMS device is dependent upon accurate measurements of these mechanical properties. In particular, the properties of interest in designing MEMS devices include the relationship between stress and strain (e.g., Young's modulus) as a function of temperature, as well as measurements of creep and fatigue.

One conventional method of characterizing thin films is described with respect to FIGS. 7A-7C. In FIG. 7A, it can be seen that a layer 60 of the thin film to be characterized has been deposited on a silicon layer 62. In FIG. 7B, a portion of the silicon layer 62 has been etched away so as to form a cavity 64 and to expose part of the layer 60 to be characterized. In FIG. 7C, the silicon layer 62 and the layer 60 have been aligned with a substrate 68, which may include an optical layer 66 disposed on the substrate 68, so as to form a test structure. The exposed portion of the layer 62 can be actuated via the application of pressure (mechanical, hydraulic, electrostatic, or other) to move through the cavity 64 relative (e.g. towards) the substrate 68. Measurement of the deflection of the layer 62 and determination of the position of the layer may be done via optical measurements, which may be assisted by the inclusion of an optical layer 66 on the substrate 68.

Another conventional method of characterizing thin films involves the use of a nano-indenter. This method utilizes a test structure including a movable layer disposed over a cavity through which the movable layer can be deflected. The test structure may be similar to the test structure of FIG. 7C, except that the optical layer 66 need not be included. A nano-indenter is brought into contact with the movable layer and a defined force is applied to the movable layer. The deflection of the movable layer can then be directly measured through measurement of the movement of the nano-indenter in contact with the movable layer.

Both of these conventional testing methods have significant limitations. Neither of the methods are well suited to characterizing the properties of the film at high temperatures, as the external equipment utilized in the testing processes, such as the nano-indenter or the optical characterization equipment, may need to be exposed to the high temperature environment. These methods also typically test the properties of the film at a single location, and generally cannot be used to determine the variation of these properties across a substrate, for example as the properties of a sputtered film may vary across the substrate. Furthermore, these methods, particularly the etching back of a silicon layer, can be challenging and costly.

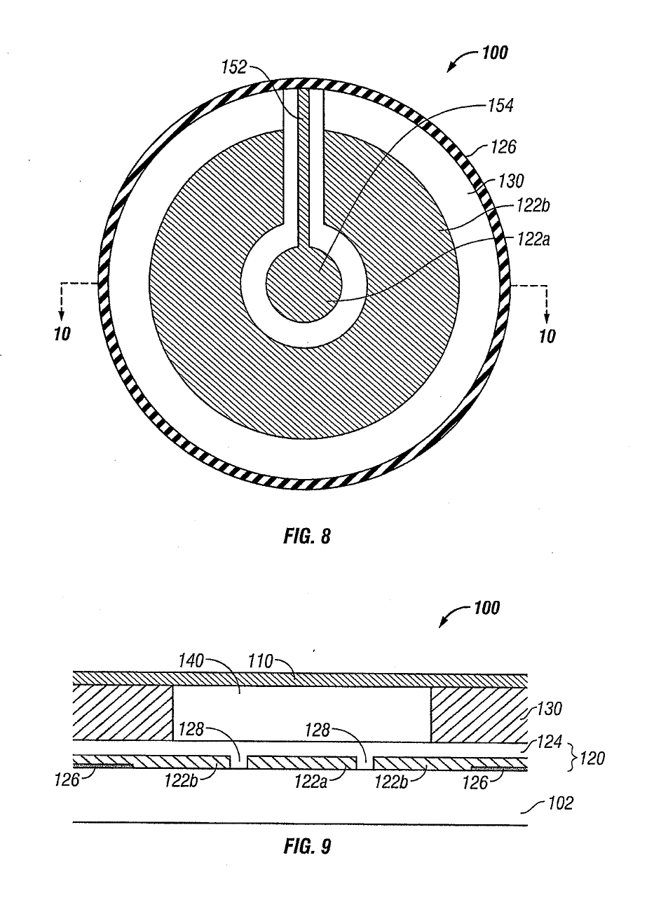

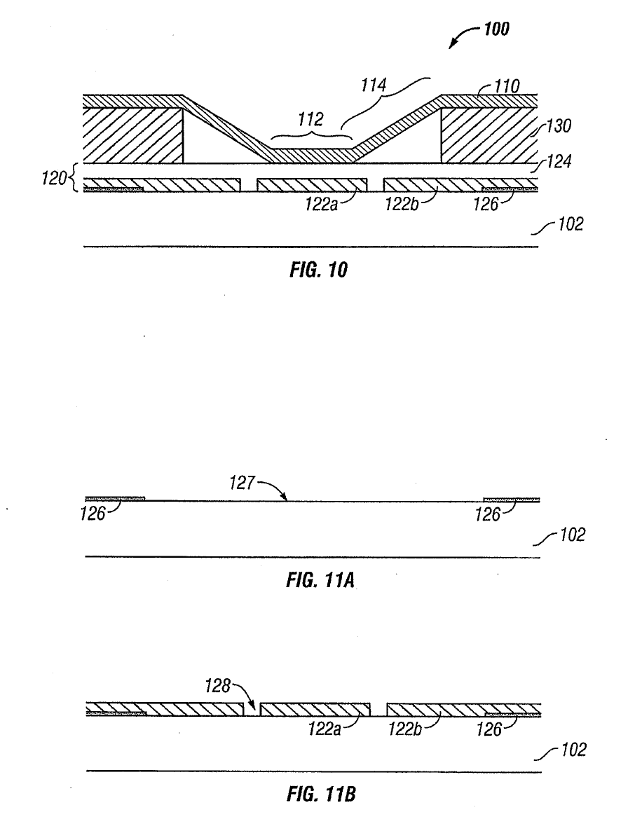

In one embodiment, a test structure may be used which functions as an interferometric modulator. FIGS. 8 and 9 illustrate an embodiment of such a test structure 100. FIG. 8 illustrates a top-down view while in FIG. 10, a cross-sectional view of the test structure 100 can be seen. The test structure 100 comprises a movable layer 110 supported over an optical stack 120 disposed over a substrate 102. The movable layer 110 is spaced apart from the optical stack 120 via one or more supports 130. The supports 130 define a cavity 140 through which a portion of the movable layer 110 can be actuated by deflecting the movable layer towards the optical stack. In the illustrated embodiment, the movable layer 110 comprises the thin film to be characterized. As will be discussed in greater detail below, the supports 130 may be formed from residual portions of a sacrificial layer used to define the cavity 140, although alternate or additional supports may be used as well. For example, a test structure may comprise supports such as the support posts 18 or 42 of FIGS. 6A and 6D-6E, or alternate structures which provide support for a movable layer. In particular embodiments, these structures may be formed and extend through the sacrificial layer prior to deposition of the movable layer over the sacrificial layer

In the illustrated embodiment, the optical stack comprises an electrode layer which may be patterned to form a driving electrode 122a and a non-driving portion 122b, separated by gaps 128 which serve to isolate the driving electrode 122a from the non-driving portion 122b. A dielectric layer 124 may be deposited over the patterned electrode layer. A black mask 126 may be disposed underneath a portion or all of the supports 130 as shown. In one embodiment, the electrode layer may comprise a partially reflective thickness of chromium or another conductive and reflective material, such as molybdenum, a molybdenum-chromium alloy, titanium, or any other suitable material. In other embodiments, the electrode layer may comprise a partially reflective layer, alternately referred to as an absorber, in addition to a conductive layer. By providing a partially reflective layer within the optical stack, the test structure can function as an interferometric modulator, facilitating measurement of the state of the test structure.

In FIG. 8, which is a bottom plan view of the test structure 100, it can be seen that the driving electrode 122a may be patterned to form a relatively thin connection portion 152 and a relatively wide central pad 154. By making the central pad 154 substantially wider than the connection portion 152, a voltage can be applied to the central pad 154 and the movable layer 110 to establish an electrostatic attractive force such that the movable layer 110 may be deformed towards the central pad 154, while the thin connection portion 152 will have little effect on the deformation of the movable layer 110.

The deformation of the movable layer 110 to a fully actuated position can be seen in FIG. 10, which shows the test structure 100 in a state in which the movable layer 110 is fully actuated. A central portion 112 of the movable layer 110 overlying the driving electrode 122a is pulled against the optical stack 120, and the portions 114 of the movable layer 110 which overlie the non-driving portion 122b of the electrode layer are not be pulled down to contact the optical stack, but instead assume a shape which is generally stretched between the edge of the central portion 112 and the edge of the support post 130. The particular shape assumed by the deformed movable layer 110 may vary at least in part on the internal stresses within the layer, as well as other factors.

### Manufacturing of Test Structures

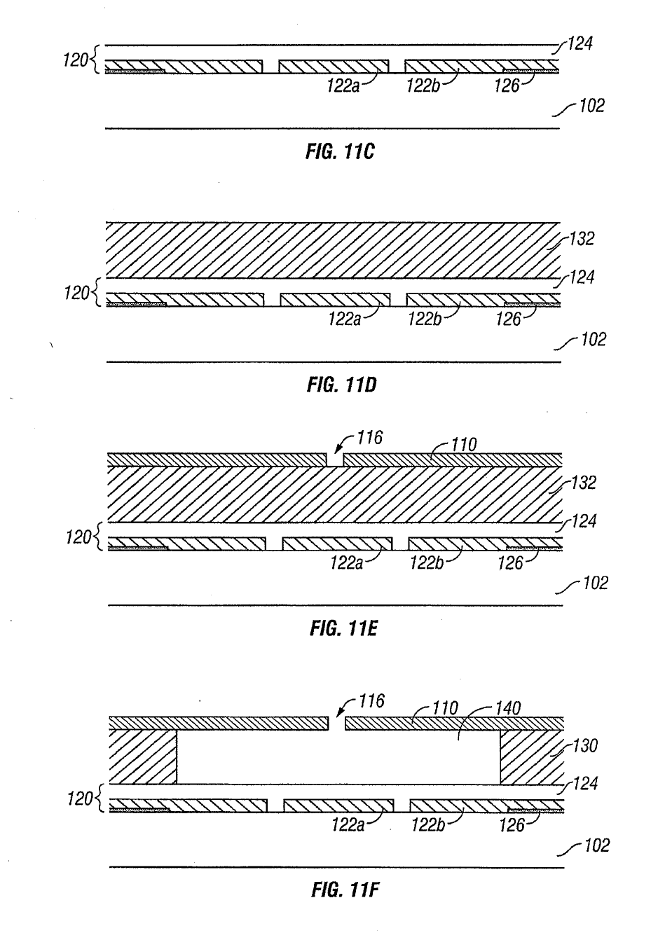

One method of fabricating such a test structure 100 is described with respect to FIGS. 11A-11F. It will be understood that such a method of fabrication may be modified so as to fabricate any of the devices described herein, and that alternate methods of fabrication may also be used to fabricate such devices. In FIG. 11A, it can be seen that a black mask 126 has been deposited on the substrate 102 and has been patterned to define an aperture 127 extending through the black mask. This aperture 127 may correspond in size and shape to the cavity 140 to be formed in the test structure 100, but may in other embodiments be larger (such as in the test structure 100 of FIGS. 9 and 10), or smaller than the cavity 140. The black mask may comprise a single layer, or may comprise multiple layers configured to interact so as to absorb light. The black mask may extend over a large portion of the substrate 102, or may extend only around the areas in which a test structure 100 is to be formed. In other embodiments, a black mask is not formed.

In FIG. 11B, it can be seen that an electrode layer has been deposited and patterned so as to form gaps 128 which define a driving electrode 122a and non-driving portions 122b. As noted above, this electrode layer may comprise a partially reflective thickness of a conductive material, such as chromium for example, or a separate partially reflective layer may be deposited, and may or may not be patterned along with the conductive electrode layer. The patterning process which forms the gaps 128 may also be used to pattern the electrode layer away from the locations of the test structure 100, e.g. to form conductive leads, contact pads, or other structures which will assist in the operation of the test structure 100.

In FIG. 11C, an insulating layer 124, such as a dielectric layer, has been deposited over the patterned electrode layer, so as to complete the optical stack 120. In the illustrated embodiment, the insulating layer 124 comprises a planarized layer, but in other embodiments the insulating layer 124 may comprise a non-planarizing layer and result in a layer which is contoured as a result of the shape of the underlying layers.

In FIG. 11D, a layer of sacrificial material 132 has been deposited over the insulating layer 124. The sacrificial layer 132 may be the same sacrificial material that will be used in the MEMS devices being designed based on the results of characterization of the test structures 100. For example, the sacrificial layer 132 may comprise Mo, Ge, a-Si, SiO2, or other materials. As noted above, the properties of a deposited thin film depend not only on the properties of the film itself, but may also depend on the underlying layer on which the thin film is deposited. Generally, deposition of a thin film under the same process conditions but on two different underlying layers can yield two thin films with differing properties.

In FIG. 11E, a movable layer 110 has been deposited over the sacrificial layer 132 and has been patterned to form an aperture 116. Although illustrated as a single aperture 116, it will be understood that the location, number, and size of these apertures may vary significantly, depending on the test structure. The formation of such apertures may serve two purposes. First, for a test structure such as test structure 100 of FIGS. 9 and 10 in which the support structure 130 takes the form of a continuous annular support structure extending around the periphery of the cavity 140, the aperture 116 exposes a portion of the underlying sacrificial layer 132, allowing the sacrificial layer 132 to be removed by being exposed to an etchant (e.g. XeF2) in a later step. The aperture 116 also permits air (or gas or fluid) to escape the cavity 140 when the test structure 100 is actuated and the movable layer 110 collapses towards the optical stack 120. Thus, the size of the aperture 116 can control the damping of the movement of the movable layer 110 as well. It will be understood that the patterning process may be used to pattern other portions of the movable layer 110 located away from test structures 100, so as to form conductive leads or other structures.

In FIG. 11F, it can be seen that a portion of the sacrificial layer 132 has been removed so as to form a cavity 140 [needs to be labeled in FIG] and supports 130. In one embodiment, the sacrificial layer 132 is removed by exposing the sacrificial material to an etchant such as XeF2 via the aperture 116. The exposure time may be controlled so as to form a cavity 140 of the desired dimensions. A test structure 100 has now been formed.

It will be understood that significant modifications may be made to the above process. For example, rather than using portions of the sacrificial layer 132 as supports 130, support structures may be formed from a different material using additional process steps. These alternate support structures 130 may provide additional rigidity, as well as additional electrical isolation between the electrode layer and the movable layer. Other modifications may also be made to the support structures 130.

It will also be understood that the above fabrication steps need not be sequentially performed at the same location. For example, it may be desirable to interrupt the fabrication process at the point corresponding to FIG. 11C, in which a precursor structure including an optical stack 120 comprising a patterned electrode has been fabricated on the substrate 102. A plurality of patterned electrodes corresponding to eventual test structure 100 locations may be provided on the substrate 102, and may in some embodiments be provided in a desired pattern. The sacrificial layer 132 and movable layer 110 may later be deposited onto the precursor structure, and the sacrificial layer 132 released by etching, to form desired test structures 100. In another alternative, the fabrication process may be interrupted at the point corresponding to FIG. 11D, in which the sacrificial layer 132 has been deposited over the optical stack 120, to generate an alternate precursor structure. The movable layer 110 may later be deposited onto the precursor structure, and the sacrificial layer 132 released by etching, to form desired test structures 100. In certain embodiments, masks may be provided with the precursor structures in order to facilitate the patterning of subsequently deposited layers so as to correspond to the patterned optical stack. A potential benefit of such precursor structures is that physically robust substrates could be provided by a manufacturer to multiple users desiring to test and characterize their thin films, without requiring the users to fabricate the precursor structures themselves. In certain embodiments, certain process steps, as well as the characterization of the resultant thin films may be performed by another party, as well.

### Characterization of Thin Films Using Test Structures

In operation, the test structure 100 may be actuated via the application of a voltage between the driving electrode 122a and the movable layer 110. If the applied voltage is less than the actuation voltage, the movable layer 100 may deform towards the driving electrode 122a, but will not collapse to contact the optical stack 120. On the other hand if the applied voltage is greater than the actuation voltage, the movable layer 110 will collapse to a position such as the one shown in FIG. 10.

Determination of the position (deflection) of the movable layer 110 can be done in at least two ways. The electrical characteristics of the test structure 100, such as the capacitance of the movable layer 110 and the driving electrode 122a, may be measured. Alternatively or in addition, optical characteristics, such as the wavelengths of light reflected at various portions of the test structure 100 may be used to determine the size of the gap between the movable layer 110 and the partially reflective layer within the optical stack 120. In an embodiment in which the movable layer 110 is to be fully actuated, the electrical characteristics of the test structure 100 can be used to provide a rapid and automatable determination of whether the movable layer 110 has collapsed against the optical stack 120. In embodiments in which the movable layer 100 is not fully actuated, the position of the movable layer 110 can be used to provide an accurate measurement of the position of the movable layer 110, both over the driving electrode 122a and across the entire test structure 100. In certain embodiments, the test device can be attached to an image capturing system, such as a camera, which can preserve a record of the reflected light in a given state (e.g., the reflectance of light and/or the various colors generated by light interference of the movable layer 110 and the optical stack 120), and can enable the analysis and determination of the position of the test structure 100 to be performed after the testing is completed.

It will also be understood, as discussed above, that an array of these test structures 100 may be fabricated so as to enable the characterization of the mechanical properties of the movable layer 110 at different locations on the substrate 102 onto which the movable layer 110 is deposited. This can be used to provide both an indication of the uniformity of the properties of the deposited thin film across the substrate 102 as well as to enable alterations to the design to be made to compensate for such variations in the mechanical properties of the movable layer 110. These devices may also be used as process control monitors, fabricated alongside other MEMS devices and used to provide an indication of the mechanical characteristics of the movable layer 110, such as the stresses within the movable layer 110.

In one embodiment, the actuation voltage of a test structure such as test structure 100 of FIG. 8 is measured by applying an increasing voltage across the driving electrode 122a and the movable layer 110. The movable layer 110 will gradually deform towards the driving electrode 122a as the voltage increases, eventually collapsing against the portion of the optical stack 120 containing the driving electrode when the actuation voltage is increased. The applied voltage may be a steadily increasing voltage (e.g., a triangular wave), or may be a series of discrete, increasing voltages. Application of a discrete voltage may be done via a constant DC voltage, or may be done via a square wave, which may in certain embodiments comprise an offset voltage. Identification of the point at which the movable layer 110 collapses may be done electrically, such as by measuring the capacitance of the test structure 100, and/or may be done optically when the portion of the test structure 100 corresponding to a driving electrode 122a assumes the color state associated with the collapsed movable layer 110.

The release voltage of the test structure 100 may be determined in a similar manner, by beginning with an actuated test structure and gradually decreasing the applied voltage until the movable layer 110 releases by moving away from the optical stack 120. Because actuation of the movable layer 110 represents a point at which the electrostatic force attracting the movable layer 110 towards the optical stack 120 overcomes the mechanical restoring force of the movable layer 110, the actuation of the movable layer 110 may result in a quick collapse (or release) of the movable layer 110 once the movable layer 110 passes the equilibrium point. It may be desirable that this actuation be quasi static, rather than dynamic, and that the escape of air or other fluid from the cavity within the test structure 100 not cause a significant damping effect on the movement of the movable layer 110. This can be accomplished through the provision of apertures in the movable layer 110, the support structure 130 of sufficient number or size. Such apertures in fluid communication with the cavity 140 can be provided in a variety of locations in the test structure 100. By making the actuation quasi-static, the actuation of the movable layer 110 is fast, enabling an accurate determination of actuation or release voltages (also referred to herein as transition voltages), and the actuation process can be accurately measured and analyzed.

The actuation voltage Vₐ can be used to provide an accurate determination of the stress within the movable layer 110, utilizing the following equation:

$${( {V}_{a} )}^{2} = \frac{8 K}{27 {ɛ}_{0} A} {( \frac{{t}_{die}}{{ɛ}_{r}} + {g}_{0} )}^{3} \qquad ( Eq . 1 )$$

where Vₐ is the magnitude of the actuation voltage in volts, and K/A is the restoring force constant of the movable layer 110 per unit area, measured in (N/m)/nm², or GPa/nm. The remaining variables are either known amounts or figures which can be readily measured. In particular, ∈₀ is the permittivity of free space (a known constant), and ∈ᵣ is the effective dielectric constant of the oxide layers, a figure which can be readily determined based upon the materials comprising the various layers within the optical stack and the thicknesses of those layers. t_{die} is the thickness of the dielectric layers within the optical stack (in nm), and g₀ is the size of the air gap (the space between the movable layer 110 and the oxide layer 120, whether the movable layer 110 is deflected or not) at the offset voltage, as measured in nm. For certain embodiments of test structures 100, g₀ may be close to the undriven air gap when the offset voltage is sufficiently low, such as when the offset voltage is less than 1V.

The stiffness of the movable layer 110 is related to the stress within the movable layer 110, and may be used to determine the same. Generally, the stiffness K of such a test structure 100 may be generally related to the stress σ via the following relationship:

K=ησt+βE (Eq. 2)

where t is the thickness of the movable layer 110, and η is dependent upon the diameter of the cavity 140. In the second term, which represents the bending stiffness, the constant β is dependent upon the geometry of the test structure, and E represents Young's modulus. However, for a thin film structure such as the test devices described herein, the bending stiffness is much smaller than the residual stress stiffness represented by the first term, and can be ignored in favor of the first term. In order to accurately determine the stiffness of the movable layer 110, finite element analysis may be utilized, taking into account the size and shape of the cavity 140, the size and shape of the bottom electrode 122a, the thickness of the movable layer 110, and the height of the cavity 140.

The release voltage may be used in a similar manner to calculate the stiffness of the movable layer 110, which can then be used to determine the stress in the movable layer 110. The release voltage Vr is related to the stiffness via the following equation:

$${( {V}_{r} )}^{2} = α \frac{2 K}{{ɛ}_{0} A} {( \frac{{t}_{die}}{{ɛ}_{r}} + {g}_{down} )}^{2} ( {g}_{0} - {g}_{down} ) \qquad ( Eq . 3 )$$

where g_{down} the down state air gap, measured in nm, and where α is a constant.

The stiffness may also be calculated via the application of a voltage V which is less than the actuation voltage. For a square wave voltage having a magnitude V and an offset Voffset, the relationship of the voltage V to the stiffness is given by the following equation:

$${( V - {V}_{offset} )}^{2} = \frac{2 K}{{ɛ}_{0} A} {( \frac{{t}_{die}}{{ɛ}_{r}} + {g}_{0} )}^{2} ( {g}_{0} - g ) \qquad ( Eq . 4 )$$

where V_{offset} is the offset voltage, and where g is the measured air gap when the voltage V is applied. The proper V_{offset} may be determined in a number of ways, such as by applied an offset voltage such that the air gap remains constant for a particular voltage. In one particular embodiment, a photodiode may be positioned adjacent the test structure 100 such that light reflected by the test structure is incident upon the photodiode. The voltage across the photodiode may be monitored, such as via an oscilloscope. When the offset voltage is improperly set, the photodiode will exhibit a swinging response having the same frequency as the applied square wave. The proper offset voltage is selected to be the offset voltage at which the voltage detected from the photodiode is stable.

In another embodiment, a number of voltages V lower than the actuation voltage may be applied, and the air gap g measured for each of the voltages V. The electrostatic force Fe being applied to the movable layer for a given voltage V can be calculated using the following equation:

$${F}_{e} = \frac{{ɛ}_{0} {AV}^{2}}{2 ( g + \frac{{t}_{die}}{{ɛ}_{0}} )} \qquad ( Eq . 5 )$$

The electrostatic force is related to the mechanical stiffness of the membrane by the following relationship:

Fₑ=K(g₀−g) (Eq. 6)

where the movable layer 110 is treated as a linear spring with a spring constant k, and wherein the electrostatic force is proportional to the change in the air gap. A plot can be generated of the electrostatic force as a function of the air gap, and then the value of the mechanical stiffness k can be determined from the plot, via an appropriate analytical method.

Once a value for k has been obtained, the actuation voltage may be estimated via Equation 1, above. In certain embodiments, the actuation voltage may be independently determined via the process described above, and the measured actuation values have been shown to be very close to the actuation voltage values determined via the present process. The present process also advantageously permits a determination of the actuation voltage in an embodiment in which full activation of the test structure 100 may be undesirable.

Finally, finite element analysis may be used to calculate the stress within the movable layer 110. As noted above, the finite element analysis may take into account a variety of factors, including the size and shape of the cavity 140, the size and shape of the driving electrode 122a, the height of the cavity 140, the movable layer 110 thickness, and the determined actuation voltage. For a particular embodiment in which the bottom electrode 122a has a radius of 75 μm, the cavity has a height of 2400 Angstroms, and the movable layer has a thickness of 1300 Angstroms, the stress is related to the actuation voltage Vₐ and the release radius Rᵣₑₗₑₐₛₑ (the radius of the released area which forms the cavity) by the following exemplary equation:

$$σ = 500 + \frac{{V}_{a}^{2} - ( 51.768 ) - ( 0.30175 ) {R}_{release}}{( 0.04164 ) - ( 0.000699 ) ( {R}_{release} - 102 )} \qquad ( Eq . 7 )$$

The particular equations generated by the finite element analysis may vary depending on the modeling used. Further, the above methods are not limited to being performed on a single test structure 100, but may be performed on multiple test structures 100 simultaneously or in series, in order to determine the mechanical characteristics of the movable layer 110 at various locations on the substrate 102. In a particular embodiment, a pattern of test structures 100 formed on the substrate 102 may be tested using one of the methods disclosed herein so as to generate various values for stress within the deposited movable layer 110 at the various locations on the substrate 102. The process conditions for depositing the movable layer 110 may also be varied during deposition of the movable layer 110, and the results compared to test structures 100 formed under different process conditions.

In other embodiments, mechanical characteristics other than the actuation voltage or stresses within the movable layer 110 may be determined. In one embodiment, fatigue behavior can be characterized by cycling the test structure 100 via the application of a periodic voltage which is configured to actuate and release the test structure 100. In particular embodiments, a square wave with an appropriately set offset voltage may be used, or triangular wave may be used, although other waveforms can be used, as well. The actuation voltage may be measured periodically as the test structure 100 is cycled, and the data may be arranged in any useful format, such as a plot of actuation voltage as a function of time or cycles. Further analysis may include the determination of the stress for the given actuation voltages, in order to characterize the stress of the movable layer 110 as a function of time or cycles. In a particular embodiment, the actuation voltage may be measured at discrete points during the process, or may in the case of a triangular or similar wave, be continuously measured by correlating the actuation of the test structure 100 with the applied voltage.

In another embodiment, the stress relaxation of the test structure 100 under load may be characterized, also referred to as creep. In one embodiment, the test structure 100 may be maintained under a constant load for a period of time, either by application of a DC voltage or a square wave or other suitable waveform. The voltage may be sufficient to fully actuate the movable layer 110, or may simply deform the movable layer 110. The actuation voltage may be periodically determined, in order to determine the stress relaxation within the movable layer 110 over time after being exposed to a given load. As the stress level is different for unactuated structures than it is for partially or fully activated structures, the stress relaxation may be measured for multiple stress levels, including unactuated or partially actuated test structures. In one embodiment, stress relaxation in an unactuated movable layer 110 may be measured by determining the residual stress in the movable layer 110, permitting the movable layer to return to an unactuated state for a period of time, and subsequently making a second determination of the residual stress movable layer 110.

As noted above, such measurements may be performed at desired temperatures. In certain embodiments, it may be desirable to form a series of test structures 100 under the same process conditions, and then perform one of the above tests sequentially on the test structures 100 at different temperature conditions, in order to determine the effect that temperature has on a mechanical characteristic such as creep rate or fatigue.

Any number of other mechanical properties may be characterized using such a test structure 100. For example, the coefficient of thermal expansion may be determined based upon the change in deflection of the movable layer 110 at particular temperatures. Such a determination need not require the application of a voltage across the test structure 100. Another measurement which can be made is a determination of Young's modulus of elasticity for the deposited film.

Generally, the stress is a function of factors such as the modulus of elasticity, the temperature, the thickness of the film, the size of the test structure 100, and the time for which the movable layer 110 has been under load. By varying any one of these factors while holding the others constant, the relationship between that factor and the mechanical characteristics of the thin film of the movable layer 110 can be determined. By characterizing the thin film deposited as the movable layer 110 in this manner, the design and operation of MEMS devices utilizing the deposited thin film layer can be optimized.

In certain embodiments, a program storage device may be provided, comprising instructions that when executed by a processor perform one of the above testing methods, or perform certain steps of one of the above testing methods. The program storage device may comprise, for example, a computer-readable medium comprising such instructions.

Thus, it will be understood that test structures and testing methods described herein may be utilized in a variety of ways, and may be modified as appropriate for use in particular embodiments. It will also be recognized that the order of layers and the materials forming those layers in the above test structures are merely exemplary. Moreover, in some embodiments, other layers, not shown, may be deposited and processed to form portions of a MEMS device or to form other structures on the substrate. In other embodiments, these layers may be formed using alternative deposition, patterning, and etching materials and processes, may be deposited in a different order, or composed of different materials, as would be known to one of skill in the art.

It is also to be recognized that, depending on the embodiment, the acts or events of any methods described herein can be performed in other sequences, may be added, merged, or left out altogether (e.g., not all acts or events are necessary for the practice of the methods), unless the text specifically and clearly states otherwise.

While the above detailed description has shown, described, and pointed out novel features of the invention as applied to various embodiments, it will be understood that various omissions, substitutions, and changes in the form and details of the device of process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of characterizing a deposited film layer, the method comprising:
providing a plurality of test structures formed on a substrate, wherein each said test structure comprises a film layer spaced apart from an electrode by a cavity, the film layer being configured to be actuated via the electrode to move into the cavity, wherein said film layer is supported by at least a residual portion of a sacrificial layer;
actuating one or more of the plurality of test structures;
determining the response of the actuated test structures; and
characterizing mechanical characteristics of the film layer based on the response of the actuated test structures.

2. The method of claim 1, wherein characterizing mechanical characteristics of the film layer comprises characterizing mechanical characteristics of the film layer at multiple locations on the substrate.

3. The method of claim 1, wherein the film layer is deposited directly over the sacrificial layer, and wherein a portion of the sacrificial layer is removed to form the cavity.

4. The method of claim 1, wherein each said test structure comprises a partially reflective layer located on a side of the cavity opposite from the film layer.

5. The method of claim 4, wherein a single layer serves as the partially reflective layer and the electrode.

6. The method of claim 1, wherein characterizing mechanical characteristics of the film layer comprises determining residual stress in the film layer.

7. The method of claim 6, wherein determining the residual stress comprises determining a transition voltage of the film layer.

8. The method of claim 6, wherein determining the residual stress comprises determining the mechanical stiffness of the film layer.

9. The method of claim 1, wherein actuating the one or more test structures comprises cyclically deforming the film layer and wherein characterizing mechanical characteristics of the film layer comprises determining residual stress in the film layer at more than one point during the actuation of the test structure.

10. The method of claim 1, wherein characterizing the mechanical characteristics of the film layer comprises determining the stress relaxation of the film layer over time.

11. The method of claim 10, wherein actuating the one or more test structures comprises deforming the film layer for a period of time, and wherein characterizing mechanical characteristics of the film layer comprises determining residual stress prior to actuating the test structures and after actuating the test structures.

12. The method of claim 11, wherein actuating the one or more test structures comprises applying a voltage sufficient to deform the film layer towards the optical stack without bringing the film layer into contact with the optical stack.

13. The method of claim 10, wherein actuating the one or more test structures comprises actuating the test structures to determine the residual stress at more than one point in time, wherein the actuated test structures are allowed to return to an unactuated position for a period of time between determinations of residual stress.

14. The method of claim 1, additionally comprising varying the temperature to which the one or more test structures are exposed.

15. A package comprising a precursor stack on a substrate for use in characterizing a film layer, the precursor stack comprising:
a substrate;
a patterned electrode layer formed over the substrate, wherein the electrode layer is patterned to define a plurality of test structure regions, each said test structure region comprising an electrode
a dielectric layer formed over the patterned electrode layer; and
a sacrificial layer formed over the dielectric layer, wherein the precursor stack on the substrate is packaged prior to patterning of the sacrificial layer.

16. The package of claim 15, wherein the substrate permits light to pass therethrough, the package additionally comprising a partially reflective layer formed between the substrate and the sacrificial layer.

17. The package of claim 15, additionally comprising instructions for characterizing the mechanical properties of a film layer deposited over the sacrificial layer.

18. A test structure for characterizing a deposited thin film layer, the test structure comprising:
an optical stack formed over a substrate, the optical stack comprising:
a driving electrode; and
an insulating layer;
and
a support formed over the optical stack, wherein the support comprises a substantially contiguous substantially annular portion of a sacrificial layer on which the thin film layer is deposited, the substantially annular portion of the sacrificial layer extending about and defining a cavity due to a portion of the sacrificial layer being removed;
wherein the deposited thin film layer is spaced apart from the optical stack by the cavity.

19. The test structure of claim 18, wherein the driving electrode is located substantially in the center of the region of the optical stack defined by the cavity, and wherein a surface area of the driving electrode is smaller than the region of the optical stack defined by the cavity.

20. The test structure of claim 18, wherein the cavity is substantially circular in shape.

21. The test structure of claim 18, wherein the test structure further comprises at least one aperture in fluid communication with the cavity.

22. A method of characterizing a deposited thin film layer, the method comprising:
providing a plurality of test structures formed on a substrate, wherein said test structures comprise a film layer spaced apart from an electrode by a cavity, the film layer being configured to be actuated via the electrode to move through the cavity;
actuating the test structures via the electrodes;
determining the response of the test structures; and
determining a mechanical stiffness of the film layer.

23. The method of claim 22, additionally comprising characterizing a mechanical property of the film layer based at least in part upon the determined mechanical stiffness.

24. The method of claim 23, wherein characterizing a mechanical property of the thin film layer comprises determining the residual stress within the film layer.

25. A test structure for characterizing a film layer, comprising:
means for reflecting at least a portion of incident light;
means for deforming the reflecting means to move into a cavity between said reflecting means and said deforming means; and
means for spacing the reflecting means apart from the deforming means, wherein said spacing means extends substantially continuously around a perimeter of the cavity.

26. The test structure of claim 25, wherein the reflecting means comprises a thin film layer.

27. The test structure of claim 25, wherein the deforming means comprise a driving electrode positioned on a side of the cavity opposite from the reflecting means.

28. The test structure of claim 25, wherein the means for spacing comprises a substantially annular portion of a sacrificial layer extending substantially continuously around a perimeter of the cavity.

29. A program storage device comprising instructions that when executed by a processor perform the method comprising:
actuating a test structure, the test structure including a thin film layer spaced apart from an optical stack by a cavity, wherein said thin film layer is supported by at least a residual portion of a sacrificial layer, wherein actuating the test structure comprises causing the thin film layer to deflect into the cavity;
determining the response of the actuated test structure; and
characterizing mechanical characteristics of the thin film layer based on the response of the actuated test structures

30. The computer-readable medium of claim 29, wherein determining the response of the test structure comprises determining the position of the test structure.

31. The computer readable medium of claim 29, wherein characterizing mechanical characteristics of the film layer comprises determining residual stress in the thin film layer.
